(19) United States
(12) Patent Application Publication
(10) Pub. No.: US 2007/0070988 A1
(43) Pub. Date: Mar. 29, 2007

(54) Method For Transmitting Deferred Messages

(76) Inventor: Lunjian Mu, Shenzhen, Guangdong Province (CN)

Correspondence Address: MCANDREWS HELD & MALLOY, LTD, 500 WEST MADISON STREET, SUITE 3400, CHICAGO, IL, 60661, US

(21) Appl. No.: 11/533,271

(22) Filed: Sep. 19, 2006

(30) Foreign Application Priority Data
Sep. 19, 2005 (CN) 200510103499.X

(51) Int. Cl. H04L 12/66; G06F 15/16

(52) U.S. Cl. 370/352; 709/206

(57) ABSTRACT

A method for transmitting deferred messages, applicable in an instant message system based on Session Initiation Protocol (SIP)/SIP Instant Message and Presence Leveraging Extensions (SIMPLE). After a client registers to the IM system and an IM server detects there are deferred messages to be sent to the client stored in the IM system, the method carries out steps of the IM server obtaining the deferred messages stored in the IM system for the client; and the IM server sending the deferred messages to the client. The present invention makes the SIP/SIMPLE IM system support a complete solution for processing deferred messages, which enriching the users' service experience and saving system resource.

### RELATED APPLICATIONS

This patent application makes reference to, claims priority to and claims benefit from Chinese Patent Application No. 200510103499.X filed on Sep. 19, 2005, which is explicitly incorporated herein by reference in its entirety.

### FIELD OF THE INVENTION

The present invention relates to instant message (IM) services in mobile communication and Internet fields, and more particularly, to a method for transmitting deferred messages to users by IM servers in an IM system based on Session Initiation Protocol (SIP)/SIP Instant Message and Presence Leveraging Extensions (SIMPLE).

### BACKGROUND

The instant message (IM) service is a kind of person-to-person or person-to-group message-type mobile data service based on the Presence service and can be developed on the mobile communication network and Internet. The mobile networks include current 2G (2nd Generation) network, 2.5 G network, future 3G network, IP Multimedia Subsystem (IMS) and the like.

Generally, there are two types of IM systems in the current industrial specifications. One is Wireless Village (WV) based, which is carried on a Hyper Text Transport Protocol (HTTP)/Wireless Access Protocol (WAP)/Short Message Service Protocol (SMS) and supports 2.5G/3G network, while the other is SIP/SIMPLE based, which is carried on a SIP/SIMPLE and supports IMS-based IP network.

In the IM system based on the SIP/SIMPLE, it is desirable that when a sender sends an instant message to a receiver, if the receiver is offline, the IM server of the receiver can store the deferred messages, and later, when the receiver registers to the SIP/IP core network and logs in the server of the receiver, the IM server will send the deferred messages to the receiver; alternatively, the IM server may send a deferred message notification to the receiver, and if the receiver would like to obtain details of the messages, it will send an obtaining request to the server and then the server will send the details of the messages to the receiver. However, the traditional SIP/SIMPLE IM systems do not provide a process of sending deferred messages to the receiver, i.e. there is no complete solution for sending deferred messages.

### SUMMARY OF THE INVENTION

The present invention provides a method for transmitting deferred messages, applicable, for example, in a Session Initiation Protocol (SIP)/SIP Instant Message and Presence Leveraging Extensions (SIMPLE) Instant Message (IM) system, which can achieve a complete deferred message obtaining process.

In accordance with certain embodiments, the present method is applicable to an IM system based on SIP/SIMPLE. When a client registers to the IM system and an IM server detects there are deferred messages stored in the IM system to be sent to the client, the IM server can carry out the following steps:

(1) obtaining the deferred messages for the client stored in the IM system; and

(2) sending the deferred messages to the client.

Prior to obtaining the deferred message contents for the client stored in the IM system, the IM server may determine whether it is necessary to send the deferred messages to the client according to pre-defined settings by the IM system or a user. If it is necessary, the method proceeds to the step of obtaining the deferred messages for the client stored in the IM system; otherwise, ends the process. The pre-defined settings can include setting requirements for sending deferred messages, and preferably, the IM server only obtains and sends to the client the deferred messages that meet the requirements for sending deferred messages.

The above method may further include a step of selecting a manner for sending the deferred messages prior to sending the deferred messages. For example, the IM server can select the manner for sending the deferred messages according to service capacity of the client, number of the deferred messages for the client, and/or size of each deferred message.

In accordance with one embodiment, the IM server sends the deferred messages to the client by an SIP MESSAGE message, and the step of sending may comprise the following steps:
sending an SIP MESSAGE message containing contents of at least one deferred message to the client by the IM server; and
returning an SIP RESPONSE message to the IM server upon receipt of the deferred message contents by the client.
   After the IM server receives the SIP RESPONSE message and if the IM server detects there are remaining deferred messages that meet the requirements for sending deferred messages, the method can repeat the steps of sending a SIP MESSAGE message containing the deferred message contents to the client and returning a SIP RESPONSE message to the IM server upon receipt of the deferred message contents until all the deferred messages meeting the requirements for sending deferred messages are sent. Alternatively, after the IM server receives the SIP RESPONSE message and if the IM server detects there are remaining deferred messages that meet the requirements for sending deferred messages, the method can repeating the step sending a SIP MESSAGE message containing the deferred message contents to the client until all the deferred messages that meet the requirements for sending deferred messages are sent.

In accordance with another embodiment, the IM server sends the deferred messages to the client by a Message Session Relay Protocol (MSRP) channel, and the method may further include the following steps:
sending an MSRP SEND message containing contents of at least one deferred message to the client by the IM server through the MSRP channel; and
returning an MSRP RESPONSE message to the IM server by the client upon receipt of the deferred message contents.
   After the IM server receives the MSRP RESPONSE message and if the IM server detects there are remaining deferred messages meeting the requirements for sending deferred messages, the method can repeat the steps of sending an MSRP SEND message containing the deferred message contents to the client through the MSRP channel and the client returning an MSRP RESPONSE message to the IM server upon receipt of the deferred messages until all the deferred messages meeting the requirements for sending deferred messages are sent. Alternatively, after the IM server receives the MSRP RESPONSE message and if the IM server detects there are remaining deferred messages meeting the requirements for sending deferred messages, the method can repeat the step of sending an MSRP SEND message that contains the deferred message contents to the client through the MSRP channel until all the deferred messages that meet the requirements for sending deferred messages are sent.

In accordance with another embodiment, if there are more than one deferred message to be sent, the MSRP SEND message in the above method contains contents of more than one deferred messages and the deferred message contents are separated in the MSRP SEND message. The number of the deferred message contents contained in the MSRP SEND message can be determined by, for example, pre-defined settings by the user or the IM system, service capacity of the client of the receiver, and/or amount of information that can be carried by the current MSRP SEND message.

After the deferred messages are sent, the method of the presently described technology may further include the following steps:
sending an SIP BYE message to the client by the IM server for requesting to disconnect the MSRP channel;
returning an SIP RESPONSE message to the IM server by the client; and
disconnecting the MSRP channel.
   The MSRP channel can be an existing MSRP channel or a newly established MSRP channel between the IM server and the client.

A new MSRP channel can be established by, for example,
sending an SIP REQUEST message to the client by the IM server to request to establish an MSRP channel;
sending a response message to the IM server by the client to acknowledge receipt of the SIP REQUEST message;
sending an SIP ACK message to the client by the IM server; and
establishing the MSRP channel between the IM server and the client.
   According to certain embodiments, the IM sever can establish the MSRP channel either prior to the step of obtaining the deferred messages for the client stored in the IM system or after buffering the deferred messages after the IM server obtains the deferred messages for the client stored in the IM system.

Preferably, when sending the deferred messages, if the IM server receives a request for stopping the process of sending the deferred messages, the IM server can stop the current process but instructs the client that there are deferred messages that are not sent. If the IM server receives a resume request, the IM server can then proceed to send the deferred messages to the client.

In certain embodiments, the SIP messages transmitted between the IM server and the client are transferred by an SIP/IP core network associated with the client.

In certain embodiments, the IM server obtains the deferred message contents from a message memory. The message memory can be, for example, a separate logical server or integrated with the IM server.

In certain embodiments, the IM server deletes the deferred messages from the system after obtaining the deferred message contents for the client stored in the IM system.

In certain embodiments, after the IM server obtains the deferred message contents for the client stored in the IM system, it marks the obtained messages and deletes all the marked deferred messages at regular intervals.

In certain embodiments, the IM server deletes the sent deferred messages in the system after receiving the response message.

In certain embodiments, the IM server obtains the deferred message contents stored in the system for the client and sets a corresponding storage expiration for the obtained deferred messages, and if a time of storing the deferred messages in the system expires, the IM server deletes the deferred messages.

In one aspect, the method for transmitting deferred messages provided in the present technology can support SIP/SIMPLE IM users to receive deferred messages, which makes the SIP/SIMPLE IM service system support the solution for deferred messages, thereby enriching the user service experience and saving system resources.

In another aspect, the presently described technology provides several methods for obtaining deferred message contents, such as transmitting the deferred message contents by an SIP MESSAGE message or by an MSRP data transfer channel, which makes it possible to choose the method according to actual condition when transmitting deferred messages, so as to improve the flexibility of system.

In a further aspect, the method for transmitting deferred message contents provided in the presently described technology will delete the transmitted deferred messages from the system, thereby saving system resources.

### BRIEF DESCRIPTION OF THE DRAWINGS

FIG. 1 is a flow chart showing a complete solution for transmitting deferred messages according to an embodiment of the present invention;

FIG. 2 is a signaling flow chart showing an IM server transmitting deferred messages by an SIP MESSAGE message according to an embodiment of the present invention;

FIG. 3 is a signaling flow chart showing an IM server transmitting deferred messages by an MSRP transfer channel according to an embodiment of the present invention.

### DETAILED DESCRIPTION OF THE INVENTION

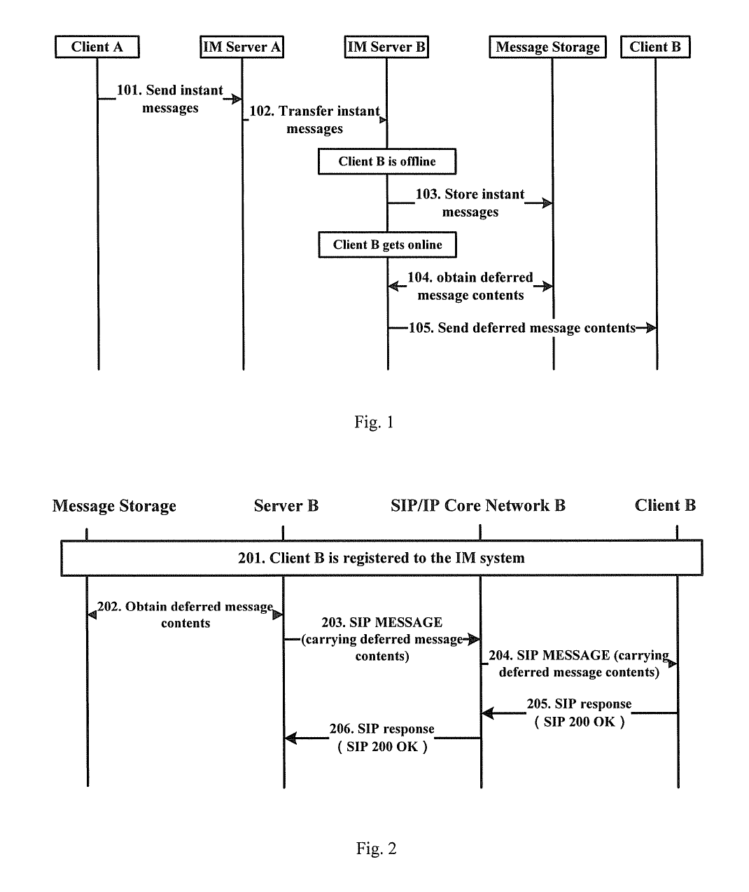

FIG. 1 is a flow chart showing a complete solution for transmitting deferred messages according to an embodiment of the present invention. As shown in FIG. 1, client A represents a client for a user as an IM sender; IM server A is the home IM server of the client A; client B represents a client for a user B as an IM receiver; IM server B is the home IM server of the client B; message memory is used to store instant messages sent by the IM sender through the client A when the client B is offline. The message memory is a logical entity, which can be integrated with the IM server B or can be a separate server. Detailed service process is described below.

Step 101. When the client A needs to send instant messages to the client B, it sends the instant messages to the IM server A first.

Step 102. If the IM server A judges that the client B belongs to the IM server B, the IM server A transfers the messages to the IM server B.

Step 103. The IM server B determines whether the client B is online, and if so, the IM server B sends the instant messages to the client B, the process ends; if not, the IM server B stores the instant messages into the message memory.

Step 104. When the client B gets online, the IM server B determines whether it needs to send the instant messages to the client B directly according to the pre-defined settings by the receiver B or by the IM system, and thus obtains from the message memory the instant messages that are sent to the client B by the client A when the client B is offline.

Step 105. The IM server B sends the obtained instant messages to the client B.

In accordance with one embodiment of the presently described technology, the client B can obtain the instant messages by the following two manners, which will be described in detail below.

The fist manner is to send the instant messages to the client by the IM server through an SIP MESSAGE message.

FIG. 2 is a signaling flow chart showing an IM server transmitting deferred messages by an SIP MESSAGE message according to an embodiment of the present invention. Referring to FIG. 2, the IM sever B and the client B belong to the same SIP/IP core network B, which is a core network portion of IMS defined by 3GPP and/or 3GPP2, such as a Call Session Control Function (CSCF) or an IP network.

When the client B is offline, if the client A sends more than one instant message to the client B, the IM server B will store the instant messages in the message memory (which is a logical entity, and can be integrated with the IM server B or can be a separate server). These instant messages stored in the message memory are the deferred messages for the client B. Whether to directly send the deferred messages to the user (the client B), what requirements shall the deferred messages meet and which manner can be used to send the deferred messages can be pre-defined settings by the user or strategies of the operator. For example, the IM server can select the manner to send deferred messages according to the service capacity of the client, the number of deferred messages for the client, and/or the size of each deferred message.

Here, it is assumed that the strategy of sending deferred messages is to send the deferred messages to the client B by an SIP MESSAGE message. The detailed signaling process for the IM server to send the deferred messages by an SIP MESSAGE message is described below.

Step 201. The client B gets online in a manner of SIP and registers to the IM server B and the SIP/IP core network B; and the IM server B learns that the client B is online.

Step 202. The IM server B detects that there are stored deferred messages for the client B and chooses to send the deferred messages by an SIP MESSAGE message, and then obtains the deferred messages for the client B from the message memory.

Step 203. The IM server B sends the SIP MESSAGE message that contains the deferred message contents for the client B to the SIP/IP core network B.

Step 204. The SIP/IP core network B transfers the SIP MESSAGE message that contains the deferred message contents for the client B to the client B.

Step 205. The client B sends an SIP 200 OK message to the SIP/IP core network B to acknowledge receipt upon receiving the deferred message contents.

Step 206. The SIP/IP core network B transfers the SIP 200 OK message to the IM server B.

If there are many deferred messages to be sent, it may repeat the above steps 203-206 until all the deferred messages meeting the requirements are sent. Obviously, the deferred messages herein are not necessarily to be sent after receiving an acknowledge response message of the previous deferred message. That is, after sending a deferred message to the client B, it may send another deferred message immediately or by a preset time interval.

Another manner to send the instant messages to the client by the IM server is through an MSRP channel.

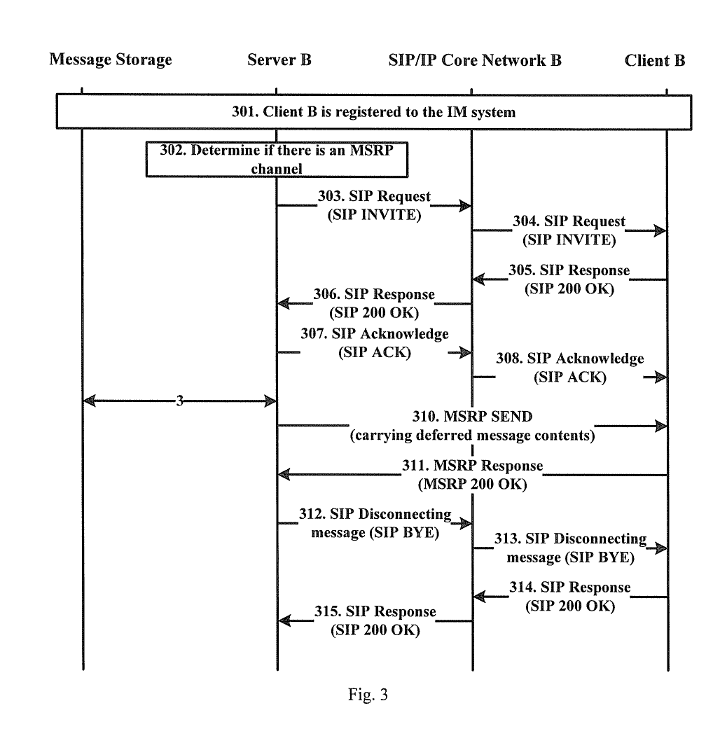

FIG. 3 is a signaling flow chart showing an IM server transmitting deferred messages by an MSRP transfer channel according to an embodiment of the present invention. Referring to FIG. 3, the IM sever B and the client B belong to a same SIP/IP core network B, which can be a core network portion of IMS defined by 3GPP and/or 3GPP2, such as a Call Session Control Function (CSCF) or an IP network.

When the client B is offline, if the client A sends more than one instant message to the client B, the IM server B will store the instant messages in the message memory (which is a logical entity, and can be integrated with the IM server B or can be a separate server). These instant messages stored in the message memory are the deferred messages for the client B. Whether to directly send the deferred messages to the user (the client B), what requirements shall the deferred messages meet and which manner can be used to send the deferred messages can be pre-defined settings by the user or strategies of the operator.

Here, it is assumed that the strategy of sending deferred messages is to send the deferred messages to the client B by an MSRP data transfer channel. The detailed signaling process for the IM server to send the deferred messages by an MSRP channel is described below.

Step 301. The client B gets online in a manner of SIP and registers to the IM server B and the SIP/IP core network B; and the IM server B learns the client B is online.

Step 302. After the IM server B detects that there are stored deferred messages for the client B and chooses to send the deferred messages by an MSRP channel, the IM server B determines if there is an MSRP channel between the IM server and the client B, and if so, proceed to step 309; otherwise, proceed to step 303.

Step 303. The IM server B sends an SIP INVITE message to the SIP/IP core network B to request to establish an MSRP channel for sending the deferred messages.

Step 304. The SIP/IP core network B transfers the SIP INVITE message to the client B.

Step 305. The client B returns an SIP 200 OK message to the SIP/IP core network B to acknowledge receipt of the SIP INVITE message.

Step 306. The SIP/IP core network B transfers the SIP 200 OK message to the IM server B.

Step 307. The IM server B sends an SIP ACK message to the SIP/IP core network B to acknowledge receipt of the SIP 200 OK message.

Step 308. The SIP/IP core network B transfers the SIP ACK message to the client B. Thus, an MSRP channel is established between the IM server and the client B.

Step 309. The IM server B obtains the deferred messages and contents for the client B from the message memory.

Step 310. The IM server B sends an MSRP SEND message that contains the deferred message contents to the client B through the established or an existing MSRP channel.

Step 311. Upon receiving the MSRP SEND message that contains the deferred message contents, the client B sends an MSRP 200 OK message to the IM server B through the MSRP channel, to acknowledge receipt of the MSRP SEND message.

If there are a plurality of deferred messages to be sent, it may repeat the above steps 310-311 until all the deferred messages meeting the requirements are sent. Obviously, the deferred messages herein are not necessarily to be sent after receiving an acknowledge response message of the previous deferred message. That is, after sending a deferred message to the client B, it may send another deferred message immediately or by a preset time interval.

For the above case where there are a plurality of deferred messages to be sent, it may determine the number of deferred messages that can be carried at one time according to how many deferred messages can be carried in the same MSRP SEND message, the pre-defined settings by the user B as a receiver or by the IM system, the service capacity of the client B, and/or the amount of information that can be carried by the current MSRP SEND message, so as to separate the deferred messages one by one in the MSRP SEND message to distinguish different deferred messages.

Step 312. After sending the deferred messages, the IM server B sends an SIP BYE message to the SIP/IP core network B, requesting to disconnect the MSRP channel between the client B and the IM server B and to end the session.

Step 313. The SIP/IP core network B transfers the SIP BYE message to the client B.

Step 314. The client B sends an SIP 200 OK message to the SIP/IP core network B, after receiving the SIP BYE message and disconnecting the MSRP channel between the client B and the IM server B.

Step 315. The SIP/IP core network B transfers the SIP 200 OK message to the IM server B, and learns that the MSRP channel between the client B and the IM server B is disconnected.

In the above method, step 309 can be carried out before step 302, i.e. the IM server B can obtain the deferred message contents for the client B from the message memory and buffer them in the IM server B before it determines whether there is an MSRP channel. No matter in which order the steps are carried out, it will not affect the effects of the presently described technology.

Therefore, in accordance with this embodiment of the present technology, the IM system can send the deferred messages to the receiver by an SIP MESSAGE message or an MSRP channel. If the MSRP channel exists, it is preferred to send the deferred messages by the MSRP channel.

When sending the deferred messages, if the IM server receives a request for stopping the process of sending the deferred messages, it may stop the current process and instruct the client that there are deferred messages that are not sent. And if the IM server receives a resume request, it may proceed to send the deferred messages to the client.

Further, in the process of transmitting deferred messages in the embodiments of the present invention, after the IM server obtains the deferred messages from the message memory, according to the pre-defined settings of the IM server, the deferred messages obtained by the IM server B and stored in the message memory may be deleted, or the deferred messages in the message memory that have been already obtained by the IM server may be marked so as to distinguish which messages are already obtained, and later the IM server may delete all the marked deferred messages in regular intervals. Of course, it may comply with the client's requirements, such as deleting the deferred messages in the message memory (immediately or by an interval) after the IM server B receives the response message from the client for acknowledging receipt of the deferred messages. Alternatively, it may set a corresponding storage expiration for the obtained deferred messages, and if a time of storing the deferred messages in the system expires, the IM server deletes the deferred messages. The processes of deleting deferred messages described above are preferred embodiments of the present invention. It is obvious that other methods are possible according to the requirements by the IM system or by the client, which will not be described in detail here.

It can be noted from the above description that the IM server may send the deferred messages to the receiver, for example, by an SIP MESSAGE message or by an MSRP data transfer channel. In combination with the traditional process of sending instant messages and storing deferred messages, a complete solution for processing deferred messages is thus obtained, which will enrich the users' service experience. And meanwhile, it may preset strategy of sending deferred messages in the system, and thus make it possible to select sending manners according to requirements of the user and the operator or the amount of information of deferred messages, thereby improving the system flexibility.

A person skilled in the art will understand that various modifications and variations can be made in the present invention without departing from the spirit and the scope of the invention. Thus, it is intended that the present invention covers the modifications and variations of this invention provided they come within the scope of the appended claims and their equivalents.

What is claimed is:

1. A method for transmitting deferred messages, applicable in an instant message (IM) system based on Session Initiation Protocol (SIP)/SIP Instant Message and Presence Leveraging Extensions (SIMPLE), wherein after a client registers to the IM system, an IM server detects there are stored deferred messages to be sent to the client, comprising the steps of:
obtaining the deferred messages for the client stored in the IM system by the IM server; and
sending the deferred messages to the client by the IM server.

2. The method according to claim 1, further comprising, prior to obtaining the deferred messages for the client stored in the IM system, determining whether it is necessary to send the deferred messages to the client according to pre-defined settings by the IM system or a user; if it is necessary, obtaining the deferred messages for the client stored in the IM system, otherwise, ending the process.

3. The method according to claim 2, wherein the pre-defined settings comprise setting requirements for sending deferred messages, and the IM server only obtains and sends to the client the deferred messages that meet the requirements for sending deferred messages.

4. The method according to claim 1, further comprising a step of selecting a manner for sending the deferred messages prior to the IM server sends the deferred messages to the client.

5. The method according to claim 4, wherein the IM server selects the manner for sending the deferred messages according to one or more of the following: service capacity of the client, number of the deferred messages for the client, and size of each deferred message.

6. The method according to claim 1, wherein the IM server sends the deferred messages to the client by an SIP MESSAGE message, and the step comprises the steps of:
(1) sending an SIP MESSAGE message containing contents of at least one deferred message to the client by the IM server; and
(2) returning an SIP RESPONSE message to the IM server by the client upon receipt of the deferred message contents.

7. The method according to claim 6, further comprising:
after the IM server receives the SIP RESPONSE message, detecting by the IM server whether there are remaining deferred messages meeting requirements for sending deferred messages to the client; and if there are,
repeating steps (1) and (2) of claim 6 until all the deferred messages meeting the requirements for sending deferred messages are sent.

8. The method according to claim 6, further comprising:
after the IM server receives the SIP RESPONSE message, detecting by the IM server whether there are remaining deferred messages meeting requirements for sending deferred messages to the client; and if there are,
repeating step (1) of claim 6 until all the deferred messages meeting the requirements for sending deferred messages are sent.

9. The method according to claim 1, wherein the IM server sends the deferred messages to the client by a Message Session Relay Protocol (MSRP) channel, and the step comprises the steps of:
(1) sending an MSRP SEND message containing contents of at lest one deferred message to the client by the IM server through the MSRP channel; and
(2) returning an MSRP RESPONSE message to the IM server by the client upon receipt of the deferred message contents.

10. The method according to claim 9, further comprising:
after the IM server receives the MSRP RESPONSE message, detecting by the IM server whether there are remaining deferred messages meeting requirements for sending deferred messages to the client; and if there are,
repeating steps (1) and (2) of claim 9 until all the deferred messages meeting the requirements for sending deferred messages are sent.

11. The method according to claim 9, further comprising:
after the IM server receives the MSRP RESPONSE message, detecting by the IM server whether there are remaining deferred messages meeting requirements for sending deferred messages to the client; and if there are,
repeating step (1) of claim 9 until all the deferred messages meeting the requirements for sending deferred messages are sent.

12. The method according to claim 9, wherein if there are a plurality of deferred messages to be sent, the MSRP SEND message contains contents of more than one deferred message and the contents of different deferred messages are separated in the MSRP SEND message.

13. The method according to claim 12, wherein the number of the deferred messages whose contents are contained in the MSRP SEND message is determined by at least one of the following:
pre-defined settings by the user or the IM system, service capacity of the client of the receiver, and amount of information that can be carried by the current MSRP SEND message.

14. The method according to claim 9, further comprising, after the deferred messages are sent:
sending an SIP BYE message to the client by the IM server for requesting to disconnect the MSRP channel;
returning an SIP RESPONSE message to the IM server by the client; and
disconnecting the MSRP channel.

15. The method according to claim 9, wherein the MSRP channel is an existing MSRP channel or a newly established MSRP channel between the IM server and the client.

16. The method according to claim 15, wherein the new MSRP channel is established by a process comprising the steps of:
sending an SIP REQUEST message to the client by the IM server to request to establish an MSRP channel;
sending a response message to the IM server by the client to acknowledge receipt of the SIP REQUEST message;
sending an SIP ACK message to the client by the IM server; and
establishing the MSRP channel by the IM server between the IM server and the client.

17. The method according to claim 15, wherein the IM sever establishes the MSRP channel prior to the step of obtaining the deferred messages for the client stored in the IM system by the IM server or after buffering the deferred messages after the step of obtaining the deferred message for the client stored in the IM system by the IM server.

18. The method according to claim 1, wherein when sending the deferred messages, if the IM server receives a request for stopping the process of sending the deferred messages, the IM server stops the current process and instructs the client that there are deferred messages that are not sent; and if the IM server receives a resume request, the IM server proceeds to send the deferred messages to the client.

19. The method according to claim 1, wherein SIP messages transmitted between the IM server and the client are transferred by an SIP/IP core network associated with the client.

20. The method according to claim 1, wherein the IM server obtains the deferred messages from a message memory.

21. The method according to claim 20, wherein the message memory is a separate logical server or is integrated with the IM server.

22. The method according to claim 1, further comprising deleting the deferred messages from the IM system after obtaining the deferred messages for the client stored in the IM system by the IM server.

23. The method according to claim 1, further comprising, after the IM server obtains the deferred messages for the client stored in the IM system, marking the obtained messages; and deleting all the marked deferred messages at regular intervals.

24. The method according to claim 6, further comprising deleting the sent deferred messages in the system after receiving the SIP RESPONSE message.

25. The method according to claim 9, further comprising deleting the sent deferred messages in the system after receiving the MSRP RESPONSE message.

26. The method according to claim 1, further comprising, after the IM server obtains the deferred messages stored in the system for the client, setting a corresponding storage expiration for the obtained deferred messages; and if the time of storing the deferred messages in the system expires, deleting the deferred messages by the IM server.
